(19) United States
(12) Patent Application Publication
(10) Pub. No.: US 2017/0088071 A1
(43) Pub. Date: Mar. 30, 2017

(54) BATTERY MANAGEMENT SYSTEM FOR VEHICLE AND CONTROLLING METHOD THEREOF

(71) Applicants: Hyundai Motor Company, Seoul (KR); Kia Motors Corporation, Seoul (KR)

(72) Inventor: Kyung In Min, Seongnam (KR)

(21) Appl. No.: 14/944,398

(22) Filed: Nov. 18, 2015

(30) Foreign Application Priority Data
Sep. 25, 2015 (KR) 10-2015-0136602

(51) Int. Cl. B60R 16/033; B60R 16/04

(52) U.S. Cl. CPC B60R 16/033; B60R 16/04

(57) ABSTRACT

A battery management system for a vehicle is provided to prevent an additional discharge of a first battery and improve marketability of the vehicle by controlling an ignition of the vehicle during an over-discharge of the first battery. The battery management system includes a sensing unit that is configured to measure currents and voltages of first and second batteries. A first relay is connected between the first battery and electronic units of the vehicle and a second relay is connected between the second battery and the controller. Additionally, the controller is configured to receive data from the sensing unit to turn off the first relay or turn on the second relay.

### CROSS-REFERENCE TO RELATED APPLICATION

This application is based on and claims the benefit of priority to Korean Patent Application No. 10-2015-0136602, filed on Sep. 25, 2015 in the Korean Intellectual Property Office, the disclosure of which is incorporated herein in its entirety by reference.

### TECHNICAL FIELD

The present disclosure relates to a battery management system for a vehicle and a controlling method thereof, and more particularly, to a technology of controlling a vehicle ignition during an over-discharge of a vehicle battery.

### BACKGROUND

In general, electronic devices for a vehicle, for example, an image recording apparatus, a path guiding apparatus, an audio and video device, and the like, for a vehicle, are connected to an outlet (e.g., 12 V power outlet) within a vehicle to be supplied with power. Among the electronic devices for the vehicle, there are devices which require continuous power supply and are required to be operated even after an ignition of the vehicle is turned off.

In particular, a black box for a vehicle is a representative example. Since the black box for the vehicle performs a function of preparing for a traffic accident, an artificial vehicle damage accident during parking of the vehicle, or the like by recording situations while driving the vehicle and situations during the parking of the vehicle, the black box requires a continuous supply of power from the vehicle as long as the black box does not use a self-battery. However, since a battery for a vehicle has limited capability of about 60 AH to 100 AH, a charged battery may be fully discharged and it may be impossible for the vehicle to be driven, when a generator is not operated since the ignition of the vehicle is not turned on.

Therefore, a technology related to an apparatus for preventing an over-discharge of a vehicle battery installed between the electronic devices for the vehicle and the vehicle battery and prevents a power supply to the electronic devices for the vehicle when a voltage of the battery is less than a predetermined level has been proposed.

### SUMMARY

The present disclosure provides a battery management system for a vehicle capable of preventing an additional discharge of a first battery and improving marketability of the vehicle by controlling an ignition of the vehicle during an over-discharge of the first battery, and a controlling method thereof.

Other objects and advantages of the present disclosure can be appreciated by the following description and will be clearly described by the exemplary embodiments of the present disclosure. It will be easily known that the objects and advantages of the present disclosure can be implemented by means and a combination thereof shown in the appended claims.

According to an exemplary embodiment of the present disclosure, a battery management system for a vehicle may include a sensing unit configured to measure currents and voltages of the first and second batteries; a first relay connected between the first battery and electronic units of the vehicle; a second relay connected between the second battery and a controller; and the controller configured to receive data from the sensing unit to turn off the first relay or turn on the second relay.

According to another exemplary embodiment of the present disclosure, a controlling method of a battery management system for a vehicle may include a turning on a first relay; determining a state of the first battery; turning on a second relay connected to the second battery; comparing a state of the second battery with a preset state; and when the state of the second battery is greater than the preset state, charging the first battery.

In the turning on of the first relay, the first relay may be connected to electronic units and may be configured to supply power to the vehicle. In the determination of the state of the first battery, a time signal measured by a sensing unit may be received to determine the state of the first battery. In addition, when the state of the second battery is less than the preset state, an operation of the battery management system for the vehicle may be terminated. After the charging of the first battery, a charged state of the first battery may be displayed on a cluster.

The controlling method may further include, after the displaying of the charged state of the first battery on the cluster, inducing, by the controller, an ignition of the vehicle. When the ignition of the vehicle is started, an operation of the battery management system for the vehicle may be terminated, and the ignition of the vehicle is not started, whether the first battery is charged may be again determined.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram illustrating a battery management system for a vehicle according to an exemplary embodiment of the present disclosure; and

FIG. 2 is a flowchart illustrating a controlling method of a battery management system for a vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/controlling unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the tem “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Advantages and features of the present disclosure and methods to achieve them will be described from exemplary embodiments described below in detail with reference to the accompanying drawings. However, the present disclosure is not limited to the exemplary embodiments set forth herein, but may be modified in many different forms. Merely, the exemplary embodiments of the present disclosure will be provided to describe the spirit of the present disclosure in detail so that those skilled in the art may easily implement the spirit of the present disclosure.

In the drawings, the exemplary embodiments of the present disclosure are not limited to illustrated specific forms, but are exaggerated for clarity. In the present specification, specific terms have been used, but are just used for the purpose of describing the present disclosure and are not used for qualifying the meaning or limiting the scope of the present disclosure, which is disclosed in the appended claims.

Hereinafter, exemplary embodiments of the present disclosure will be described in detail with reference to the accompanying drawings.

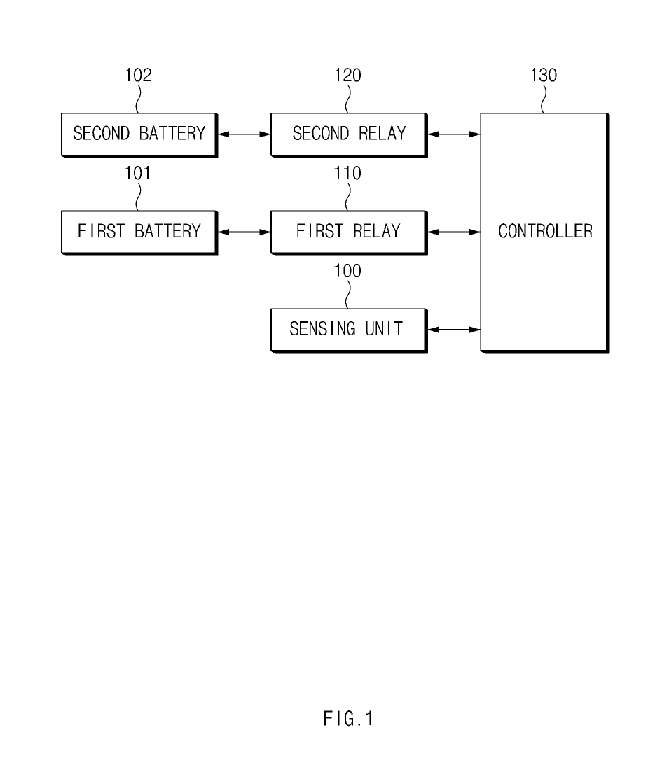

FIG. 1 is a configuration diagram illustrating a battery management system for a vehicle according to an exemplary embodiment of the present disclosure. Referring to FIG. 1, the battery management system for the vehicle may include a sensing unit 100, a first relay 110, a second relay 120, and a controller 130. The controller 130 may be configured to operate the other various units of the battery management system.

The sensing unit 100 may be configured to measure currents and voltages of a first battery 101 (e.g., an auxiliary battery, a vehicle battery, or a lithium battery) and a second battery 102 (e.g., a main battery and a high voltage battery) and may include a plurality of sensors including a power circuit unit, a voltage sensing, and cell balancing unit, a current and temperature sensing relay controller, a communicating unit, and the like. In particular, the power circuit unit may be configured to calculate a state of charge (SOC) and a state of health (SOH) of a battery for predetermined time intervals, measure a voltage, may include a real time clock (RTC), and may be configured to transmit a time signal to the battery management system for the vehicle every a predetermined time.

Further, the voltage sensing and cell balancing unit may be configured to perform a voltage sensing and balancing of a unit cell of the battery. In particular, the voltage sensing and cell balancing unit may be configured to receive a voltage sensed signal from the battery and transmit a cell balanced signal to the battery. The current and temperature sensing relay controller may include a plurality of sensors configured to measure currents and temperatures, and turn-on or off the relay between the battery and electronic units based on sensed currents and temperatures. The communicating unit may be configured to use a local interconnect network (LIN) communication method, a controller area network (CAN) communication method, or the like, as a communication method between the battery and the battery management system for the vehicle.

The first relay 110, which may be configured to turn a current on or off between the first battery 101 and the electronic units, may be configured to prevent an over-charge or an over-discharge of the battery and prevent consumption of the current of the battery by dark currents flowing in the electronic units. The second relay 120, which may be configured to turn a current on or off between the second battery 102 (e.g., the high voltage battery) and the controller, may be configured to operate a low direct-current/direct-current (DC/DC) converter (LDC) to charge the vehicle battery when a state of the second battery (e.g., the SOC or SOH of the second battery) is equal to or greater than a set state of the battery.

The controller 130, which may be configured to operate the sensing unit 100, the first relay 110, and the second relay 120, may be connected to a variety of sensors or components included within the sensing unit through a circuit, and may be configured to execute a power transfer operation of the relay and an interruption of the power transfer operation of the relay based on data received via the connected circuit. When the SOC of the first battery or the SOH of the first battery is a predefined sleep reference value or less, the controller 130 may be configured to turn off the first relay 110.

In addition, the controller 130 may be configured to receive the data from the sensing unit 100 every the predefined sleep time (e.g., every interval) when a driving of the vehicle has ended, and may be configured to receive the data from the sensing unit 100 when the sleep time varied based on the currents and the voltage measured by the sensing unit 100 elapses. In addition, when the battery is not charged within a predefined standby time after an on-switch turns on the first relay 110, the controller 130 may be configured to turn off the first relay 110.

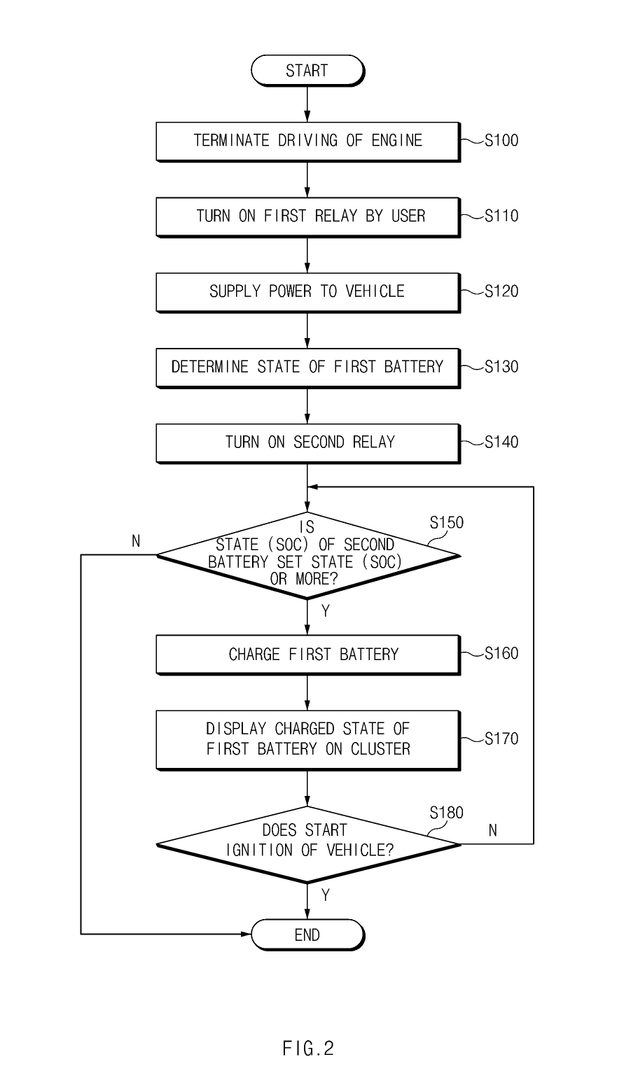

FIG. 2 is a flowchart illustrating a controlling method of a battery management system for a vehicle according to an exemplary embodiment of the present disclosure. Referring to FIG. 2, a battery management system for a vehicle according to an exemplary embodiment of the present disclosure may include a sensing unit configured to measure currents and voltages of a first battery and a second battery, a first relay connected between the first battery and electronic units of the vehicle, a second relay connected between the second battery and a controller, and the controller configured to receive data from the sensing unit to turn off the first relay or turn on or off the second relay.

Hereinafter, a controlling method of a battery management system for a vehicle will be described in detail. After a driver or a user terminates a driving of an engine, the battery management system for the vehicle may be configured to measure the voltage and the current of the first battery. Then, in response to determining based on the measured voltage and current that a measured state of the battery is a predefined sleep reference value or less, the battery management system for the vehicle may be configured to turn off the first relay connected between the first battery and the electronic units of the vehicle (S100).

Further, when the driver or the user turns on the first relay to drive the vehicle (e.g., the controller receives a turn on signal at the first relay), the first relay may be configured to supply power to the vehicle while being connected to the electronic units (S110 and S120). The sensing unit of the battery management system for the vehicle may be configured to measure a time (e.g., initial a timer), and the controller may be configured to receive a time signal measured by the sensing unit to determine a state of the first battery (e.g., an SOC of the battery or an SOH of the battery) (S130). The controller may then be configured to turn on the second relay connected to the second battery (S140) and compare a state of the second battery with a preset state (S150). When the state of the second battery is the preset state or greater (e.g., the SOC of the second battery is greater than a preset SOC of the battery), the controller may be configured to operate a low DC/DC converter (LDC) to charge the first battery (S160).

However, when the state of the second battery is the preset state or less (e.g., the SOC of the second battery is less than the preset SOC of the battery), the controller may be configured to terminate an operation of the battery management system for the vehicle. The controller may be configured to display a charged state of the first battery on a cluster and induce an ignition of the vehicle (S 170). When the driver starts the ignition of the vehicle, the controller may be configured to terminate the operation of the battery management system for the vehicle. When the driver does not start the ignition of the vehicle for a predetermined time, the controller may again be configured to compare the state of the second battery with the set state and then determine whether the first battery is sufficiently charged (S180).

As described above, according to the exemplary embodiments of the present disclosure, the ignition of the vehicle may be controlled during the over-discharge of the first battery, thereby making it possible to prevent the over-discharge of the first battery. Further, the over-discharge of the first battery may be prevented, thereby making it possible to significantly improve marketability of the vehicle of the driver.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A controlling method of a battery management system for a vehicle connected between a first battery and a second battery, the controlling method comprising:
receiving, by the controller, a turn on signal at a first relay;
determining, by the controller, a state of the first battery;
turning on, by the controller, a second relay connected to the second battery;
comparing, by the controller, a state of the second battery with a preset state; and
when the state of the second battery is greater than the preset state, charging, by the controller, the first battery.

2. The controlling method according to claim 1, wherein in the turning on of the first relay, the first relay is connected to electronic units and is configured to supply power to the vehicle.

3. The controlling method according to claim 1, wherein in the determination of the state of the first battery, a time signal measured by a sensor is received by the controller to determine the state of the first battery.

4. The controlling method according to claim 1, wherein in the comparison of the state of the second battery with the preset state, when the state of the second battery is less than the preset state, an operation of the battery management system for the vehicle is terminated.

5. The controlling method according to claim 1, wherein after the charging of the first battery, a charged state of the first battery is displayed by the controller on a cluster.

6. The controlling method according to claim 5, further comprising:
after displaying the charged state of the first battery on the cluster, inducing, by the controller, an ignition of the vehicle.

7. The controlling method according to claim 6, wherein when the ignition of the vehicle is started, an operation of the battery management system for the vehicle is terminated, and when the ignition of the vehicle is not started, the controller is configured to determine whether the first battery is charged.

8. A battery management system for a vehicle connected between a first battery and a second battery, the battery management system comprising:
a sensing unit configured to measure currents and voltages of the first and second batteries;
a first relay connected between the first battery and electronic units of the vehicle;
a second relay connected between the second battery and a controller; and
the controller configured to receive data from the sensing unit to turn off the first relay or turn on the second relay.

9. The battery management system of claim 8, wherein the controller is configured to:
determine a state of the first battery;
turn on the second relay connected to the second battery;
compare a state of the second battery with a preset state; and
when the state of the second battery is greater than the preset state charge the first battery.

10. The battery management system of claim 9, wherein when the state of the second battery is less than the preset state, an operation of the battery management system for the vehicle is terminated.

11. The battery management system of claim 9, wherein after the charging of the first battery, a charged state of the first battery is displayed by the controller on a cluster.
